(19) United States
(12) Patent Application Publication
(10) Pub. No.: US 2003/0102729 A1
(43) Pub. Date: Jun. 5, 2003

(54) Motor device for electrical compressor

(76) Inventor: Masami Sanuki, Chiryu-city (JP)

Correspondence Address: POSZ & BETHARDS, PLC, 11250 ROGER BACON DRIVE, SUITE 10, RESTON, VA, 20190, US

(21) Appl. No.: 10/283,211

(22) Filed: Oct. 30, 2002

(30) Foreign Application Priority Data
Oct. 30, 2001 (JP) 2001-332749
Oct. 4, 2002 (JP) 2002-292310

(51) Int. Cl. H02K 9/00

(52) U.S. Cl. 310/58; 310/64

(57) ABSTRACT

In a motor device for an electrical compressor, a heat insulation portion is provided between an inner wall of a motor housing and an outer wall of a stator of a motor portion at least at a position corresponding to a position of an electrical circuit integrated with the motor housing. Therefore, it can restrict heat generated in the motor portion from being transmitted to the electrical circuit. In addition, a refrigerant inlet for introducing refrigerant into the motor portion is provided in the motor housing so that low-temperature refrigerant before being sucked into a compression mechanism can be readily introduced into the heat insulation portion. Accordingly, thermal damage of the electrical circuit can be effectively prevented.

### CROSS REFERENCE TO RELATED APPLICATION

This application is based on Japanese Patent Applications No. 2001-332749 filed on Oct. 30, 2001 and No. 2002-292310 filed on Oct. 4, 2002, the disclosure of which is incorporated herein by reference.

### BACKGROUND OF THE INVENTION

1. Field of the Invention

The present invention relates to a motor device in which an electrical circuit such as an inverter circuit for driving a motor portion is integrated to a motor housing of the motor portion. The motor device is suitably used for an electrical compressor in a vapor-compression type refrigerant cycle for an air conditioner.

2. Description of Related Art

In an electrical compressor described in JP-U-62-12471, a compression portion, a motor and an electrical circuit for driving the motor are integrated. In this integrated structure, because the electrical circuit is simply integrated to a side surface of a motor housing, heat generated in the motor is transmitted to the electrical circuit through a motor housing. Therefore, electrical parts such as a semiconductor for constructing the electrical circuit may be damaged by the heat from the motor.

### SUMMARY OF THE INVENTION

In view of the above-described problems, it is an object of the present invention to provide a motor device having an electrical circuit integrated to a housing of a motor portion, which prevents thermal damage of the electrical circuit due to heat from a motor portion.

According to the present invention, in a motor device, an electrical circuit for driving a motor portion is disposed integrally with a housing of the motor portion at an integrated position, and a heat insulation portion is provided between an inner wall of the housing and an outer wall of a stator fixed into the housing, at least at a position corresponding to the integrated position of the electrical circuit, to reduce a heat transmission rate per unit time at the integrated position. Therefore, it can restrict heat generated in the motor portion from being transmitted to the electrical circuit. Accordingly, it can prevent a thermal damage of the electrical circuit due to the heat from the motor portion, and reliability and life of the motor device can be effectively improved.

Preferably, the heat insulation portion is defined by a space between the inner wall of the housing and the outer wall of the stator. For example, a part of the inner wall of the housing is recessed to a side opposite to the outer wall of the stator to define the space. Therefore, the heat insulation portion can be readily provided. Alternatively, the heat insulation portion is a heat insulation material disposed between the inner wall of the housing and the outer wall of the stator at least at the position corresponding to the integrated position of the electrical circuit.

When a compression portion for sucking and compressing a fluid is integrated to the housing at one axial end side of the housing, the compression portion is connected to the motor portion such that the fluid is sucked into the compression portion after flowing in the motor portion. Thus, it can accurately prevent heat generated in the motor portion from being transmitted to the electrical circuit. More preferably, the inlet port is provided in the housing at a side of the electrical circuit. Therefore, low-temperature fluid before being compressed in the compression portion can be readily introduced into the heat insulation portion in the housing.

### BRIEF DESCRIPTION OF THE DRAWINGS

Other objects, features and advantages of the present invention will become more apparent from the following detailed description made with reference to the accompanying drawings, in which:

FIG. 1 is a partially sectional view showing an electric compressor according to a first embodiment of the present invention;

FIG. 2 is a cross-sectional view taken along line II-II in FIG. 1; and

FIG. 3 is a sectional view showing an electric compressor according to a second embodiment of the present invention.

### DETAILED DESCRIPTION OF THE PREFERRED EMBODIMENTS

(First Embodiment)

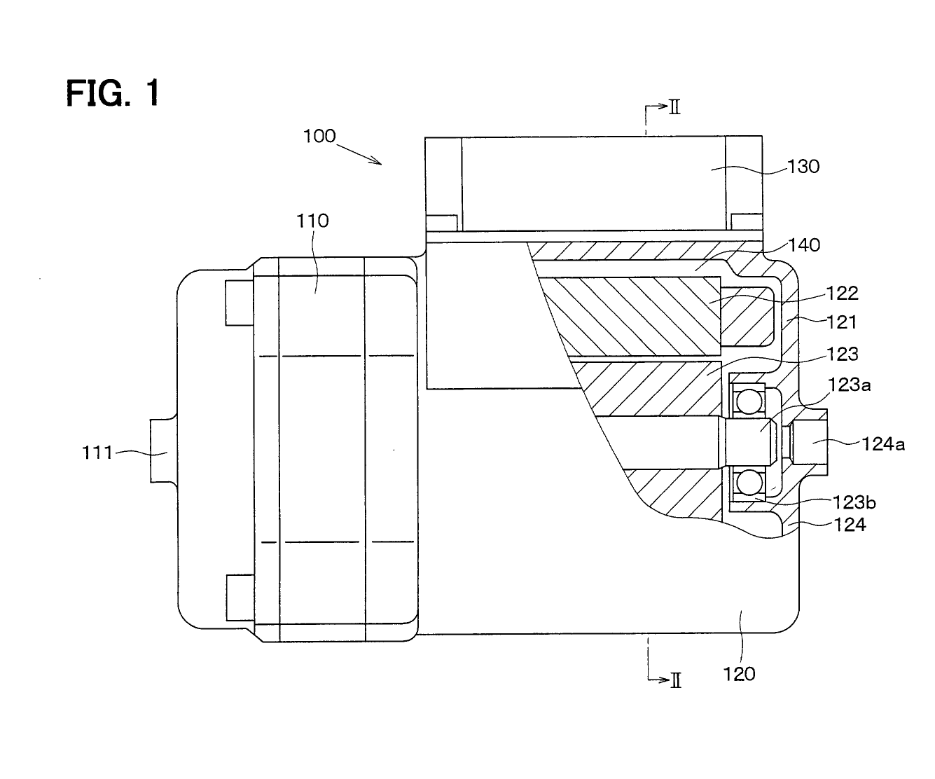

In the first embodiment, the present invention is typically applied to an electrical compressor of a vapor-compression type refrigerant cycle for a vehicle air conditioner. As shown in FIG. 1, an electrical compressor 100 includes a scroll-type compression mechanism 110 for sucking and compressing refrigerant, a DC brushless electrical motor 120 for driving the compression mechanism 110, and an electrical circuit 130 made of an inverter circuit for driving the electrical motor 120. The compression mechanism 110 and the electrical motor 120 are integrated to be arranged in serious on the same shaft. The structure of the electrical motor 120 will be described later.

The compression mechanism 110 and the electrical motor 120 are disposed in a motor housing 121, and the electrical circuit 130 is attached to an outer surface of the motor housing 121 by using a fastening member such as bolts, so that the electrical circuit 130 is integrated to the compression mechanism 110 and the electrical motor 120.

The electrical compressor 100 is assembled and fixed to a crank case of a vehicle engine such that the electrical circuit 130 is positioned opposite to the vehicle engine relative to the electrical motor 120. In the first embodiment, the electrical compressor 100 is assembled to the crank case of the vehicle engine. However, when the electrical compressor 100 is used for an electrical vehicle or a hybrid vehicle using an electrical motor as a vehicle driving source, the electrical compressor 100 can be assembled to a vehicle body.

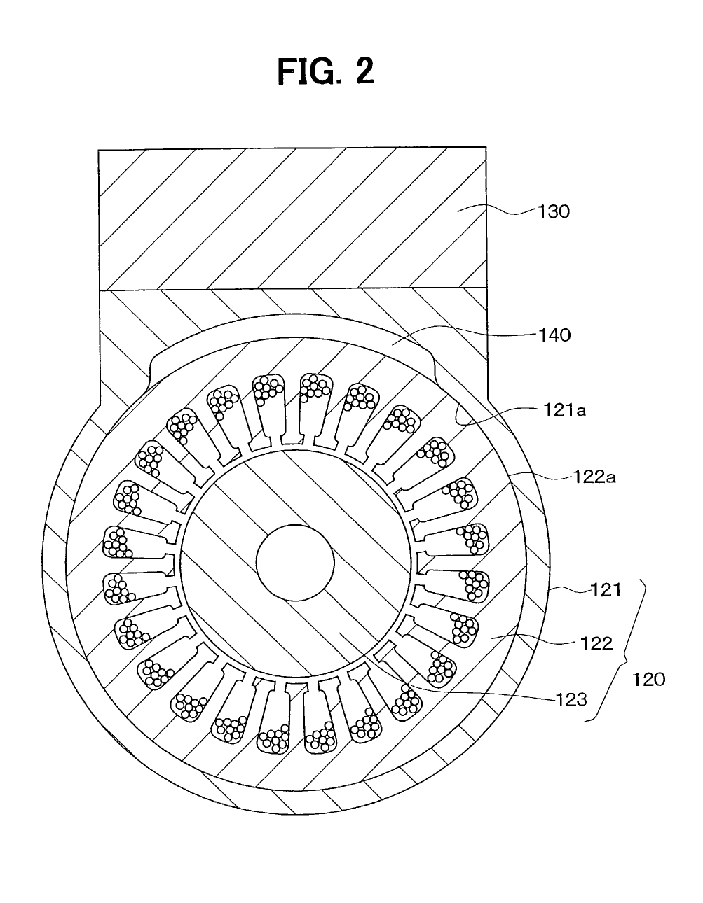

As shown in FIG. 2, the electrical motor 120 includes the motor housing 121 made of an aluminum material, a stator 122 press-fitted to the motor housing 121, and a rotor 123 rotatable in the stator 122. A part of the motor housing 121, except for the part where the electrical circuit 130 is assembled, is formed into an approximate cylindrical shape. One axial end portion of the motor housing 121 at a side opposite to the compression mechanism 110 is closed by a motor cover 124 to be integrated with the motor housing 121. A refrigerant inlet 124a is provided in the motor cover 124, and is coupled to a low-pressure side heat exchanger of the refrigerant cycle. Further, a shaft bearing 123b for rotatably supporting one side end of a shaft 123a of the rotor 123 is attached to the motor cover 124.

On the other hand, a discharge port 111 is provided in an axial end of the electrical compressor 100, at a side opposite to the motor cover 124. Therefore, refrigerant flows into the motor housing 121 from the refrigerant inlet 124a, is compressed in the compression mechanism 110, and is discharged toward a high-pressure side heat exchanger of the refrigerant cycle from the discharge port 111.

As shown in FIG. 2, a heat insulation portion 140 is provided between an inner wall 121a of the motor housing 121 and an outer wall 122a of the stator 122, at least at a circumference position corresponding to an integrated position where the electrical circuit 130 is integrated to the motor housing 121. By providing the heat insulation portion 140, heat transmission amount per unit time from the stator 122 to the electrical circuit 130 can be made smaller as compared with the other portion where the heat insulation portion 140 is not provided. In the first embodiment, a recess portion recessed from the inner wall 121a of the motor housing 121 to a side opposite to the stator 122 is provided so that a clearance having a predetermined space is provided between the inner wall 121a of the motor housing 121 and the outer wall 122a of the stator 122. In this embodiment, the heat insulation portion 140 is constructed by the space between the inner wall 121a of the motor housing 121 and the outer wall 122a of the stator 122.

According to the first embodiment of the present invention, the heat insulation portion 140 is provided between the inner wall 121a of the motor housing 121 and the outer wall 122a of the stator 122, at least at the position corresponding to the integrated position of the electrical circuit 130 integrated with the motor housing 121. Therefore, it can restrict heat generated from the electrical motor 120 from being transmitted to the electrical circuit 130. Accordingly, thermal damage of the electrical circuit 130 due to the heat from the electrical motor 120 can be prevented, and the reliability and the life of the electrical compressor 100 can be improved.

In the electrical compressor 100, the suction refrigerant having relative low temperature before being compressed in the compression mechanism 110 flows into the motor housing 121. Further, the space defining the heat insulation portion 140 has an opening area opened to an inlet passage of the refrigerant inlet 124a. The opening area of the heat insulation portion 140 is made larger than that of a clearance between the stator 122 and the rotor 123, so that the low-temperature suction refrigerant tends to readily flow into the heat insulation portion 140 in the electrical motor 120. Accordingly, it can effectively restrict heat generated in the electrical motor portion 120 from being transmitted to the electrical circuit 130.

(Second Embodiment)

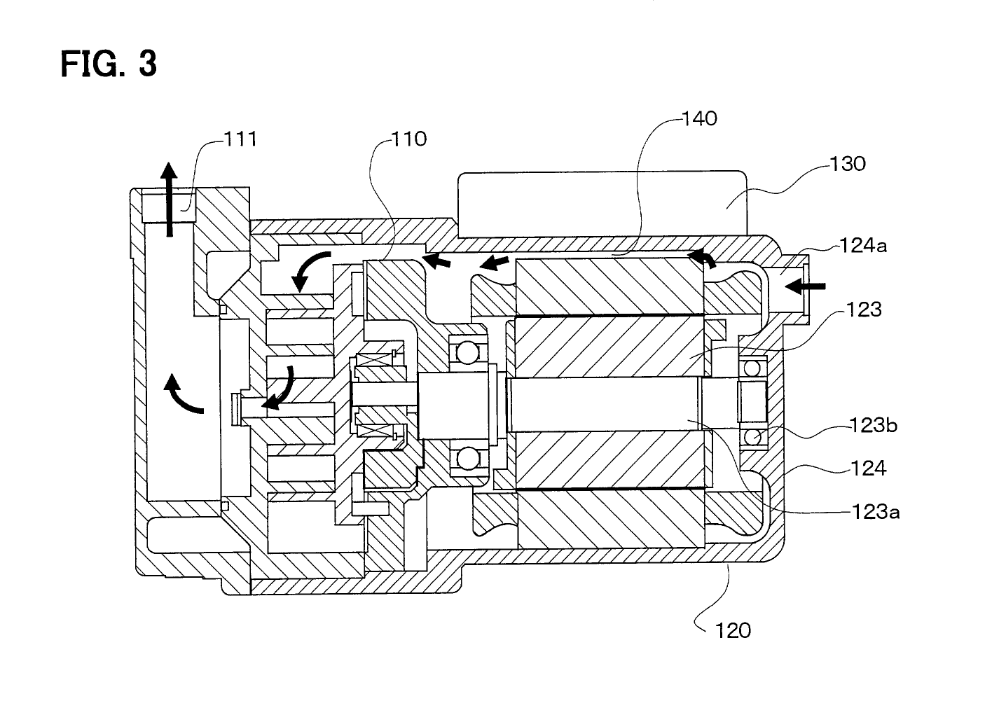

In the above-described first embodiment, the refrigerant inlet 124a is provided in the motor cover 124 at a position corresponding to the one axial end portion of the shaft 123a. However, in the second embodiment, as shown in FIG. 3, the refrigerant inlet 124a is provided in the motor cover 124 at a position corresponding to the heat insulation portion 140 in a radial direction. That is, the refrigerant inlet 124a is provided in the motor cover 124 at an outer radial position on the side of the electrical circuit 130. Accordingly a pressure loss of a refrigerant passage from the refrigerant inlet 124a to the heat insulation portion 140 can be made smaller, and a large amount of low-temperature refrigerant flowing into the motor housing 120 flows into the space defining the heat insulation portion 140. Thus, it can sufficiently restrict heat generated in the electrical motor 120 from being transmitted to the electrical circuit 130.

Although the present invention has been fully described in connection with the preferred embodiments thereof with reference to the accompanying drawings, it is to be noted that various changes and modifications will become apparent to those skilled in the art.

For example, in the above-described first and second embodiments, the recess portion is provided in the motor housing 121 so that the heat insulation portion 140 is constructed. However, the heat insulation portion 140 can be provided by forming the recess portion in the stator 122.

Further, the heat insulation portion 140 can be constructed by a heat insulation material such as a resin having a small heat transmission rate, disposed between the inner wall 121a of the motor housing 121 and the outer wall 122a of the stator 122 at least at the position corresponding to the integrated position of the electrical circuit 130.

In the above-described embodiments of the present invention, the heat insulation portion 140 can be provided at plural positions symmetrically around the center axis of the stators 122 and the motor housing 122. Further, the heat insulation portion 140 can be provided at plural positions between the inner wall 121a of the motor housing 121 and the outer wall 122a of the stator 122.

Further, the present invention can be applied to a motor device without the compression mechanism integrated with the motor housing.

Such changes and modifications are to be understood as being within the scope of the present invention as defined by the appended claims.

What is claimed is:

1. A motor device comprising:
an electrical motor portion including a housing, a stator disposed in the housing to be fixed to the housing, and a rotor rotatable in the stator;
an electrical circuit, disposed integrally with the housing at an integrated position, for driving the motor portion; and
a heat insulation portion provided between an inner wall of the housing and an outer wall of the stator at least at a position corresponding to the integrated position of the electrical circuit, to reduce a heat transmission rate per unit time.

2. The motor device according to claim 1, wherein the heat insulation portion is defined by a space between the inner wall of the housing and the outer wall of the stator.

3. The motor device according to claim 2, wherein a part of the inner wall of the housing is recessed to a side opposite to the outer wall of the stator to define the space.

4. The motor device according to claim 1, wherein the heat insulation portion is a heat insulation material disposed between the inner wall of the housing and the outer wall of the stator at least at the position corresponding to the integrated position of the electrical circuit.

5. The motor device according to claim 2, further comprising
a compression portion for sucking and compressing a fluid, the compressor being integrated to the housing at one axial end side of the housing.

6. The motor device according to claim 5, wherein the compression portion is connected to the motor portion such that the fluid is sucked into the compression portion after flowing in the motor portion.

7. The motor device according to claim 5, wherein:
the housing has an inlet port provided in the housing, such that the fluid before being sucked into the compression portion flows into the motor portion from the inlet port to pass through the heat insulation portion.

8. The motor device according to claim 7, wherein the inlet port is provided in the housing at a side of the electrical circuit.
